(19) United States
(12) Patent Application Publication
(10) Pub. No.: US 2008/0185100 A1
(43) Pub. Date: Aug. 7, 2008

(54) APPARATUS AND METHOD FOR A SEPARATING FILM

(75) Inventors: Yun JANG, Suwon-si (KR); Jae-Jin LYU, Yongin-si (KR); Seung-Hyun HUR, Cheonan-si (KR); Sang-Gun CHOI, Suwon-si (KR); Seung Hee LEE, Seoul (KR); Joon Hyung PARK, Seoul (KR); Myeong-Ha KYE, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 11/928,598

(22) Filed: Oct. 30, 2007

(30) Foreign Application Priority Data
Feb. 1, 2007 (KR) 10-2007-0010587

(51) Int. Cl. B32B 43/00

(52) U.S. Cl. 156/344; 156/584

(57) ABSTRACT

In an apparatus for separating a film from a substrate, a separating roller separates a film attached to the substrate and a guide roller adjusts a separation angle of the film. The guide roller is disposed between the separating roller and the film and the position of the guide roller relative to the separating roller is adjusted to adjust the separation angle of the film.

### CROSS-REFERENCE TO RELATED APPLICATION

This application claims priority from and the benefit of Korean Patent Application No. 10-2007-0010587, filed on Feb. 1, 2007, which is hereby incorporated by reference for all purposes as if fully set forth herein.

### BACKGROUND OF THE INVENTION

1. Field of the Invention

The present invention relates to an apparatus and a method for separating a film. More particularly, the present invention relates to an apparatus and a method of separating a film that may be capable of improving use-efficiency of the product.

2. Discussion of the Background

In general, a liquid crystal display includes a liquid crystal display panel to display an image using light and a backlight assembly to provide light to the liquid crystal display panel. The liquid crystal display panel may be provided with polarizing plates, which polarize light, on an upper portion and a lower portion thereof. The polarizing plate provided on the lower portion of the liquid crystal display panel polarizes light from the backlight assembly and provides the light to the liquid crystal display panel. The polarizing plate provided on the upper portion of the liquid crystal panel polarizes the light from the liquid crystal display panel.

Such a polarizing plate may be removed when an error, such as a misalignment error, occurs or during a rework process of the liquid crystal display panel. A method of separating the polarizing plate is described below. First, a portion of the polarizing plate may be fixed to a separating roller. Then, the separating roller rotates while moving in one direction, so that the polarizing plate may be separated from the liquid crystal display panel. The polarizing plate separated in this process is wound around the separating roller. Recently, polarizing plates have become slimmer to reduce the manufacturing cost and improve reliability. Therefore, in the process of separating the polarizing plate from the liquid crystal display panel, the polarizing plate may not be completely separated from the liquid crystal display panel and may be torn.

In order to prevent the polarizing plate from being torn, an additional film may be attached to the polarizing plate to increase a thickness of the polarizing plate. However, this increases the number of processes and the process time. Alternatively, the speed at which the polarizing plate is separated from the liquid crystal display panel may be reduced, but this also increases the process time. It is also possible to reduce the adhesive force of the polarizing plate, but that may result in tension being applied to the polarizing plate when the polarizing plate is repeatedly contracted and expanded due to the ambient temperature and humidity variation, which may cause light leakage at an edge of the polarizing plate.

In addition, the polarizing plate may be torn during the rework process when a specific angle is formed between the polarizing plate and the liquid crystal display panel. The angle between the polarizing plate and the liquid crystal display panel may not be adjusted by the separating roller, and the specific angle causing the polarizing plate to be torn varies depending on the material of the polarizing plate. Therefore, adjusting the specific angle may be very difficult.

### SUMMARY OF THE INVENTION

The present invention provides an apparatus for separating a film that may be capable of separating the film with a high success rate, thereby improving use-efficiency of products.

The present invention also provides a method of separating a film using the above apparatus.

Additional features of the invention will be set forth in the description which follows, and in part will be apparent from the description, or may be learned by practice of the invention.

The present invention discloses an apparatus for separating a film from a substrate including a stage on which the substrate may be disposed, a separating roller, and a guide roller. The separating roller is moveable in a first direction to separate the film from the substrate. The guide roller is provided adjacent to the stage and the separating roller to adjust a separation angle between the film and the substrate.

The present invention also discloses a method of separating a film including disposing a substrate on a stage and disposing a separating roller on a film of the substrate. A portion of the film is fixed to the separating roller. A separation angle between the film and the substrate is adjusted using a guide roller. The separating roller moves in a first direction to separate the film from the substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of this specification, illustrate embodiments of the invention, and together with the description serve to explain principles of the invention.

FIG. 1 is a perspective view showing an apparatus for separating a film according to an exemplary embodiment of the present invention.

FIG. 2 is an exploded perspective view showing a display panel assembly shown in FIG. 1.

FIG. 3 is a sectional view taken along line I-I′ shown in FIG. 1.

FIG. 4 is a flowchart showing a method of separating a first polarizing plate according to an exemplary embodiment of the present invention.

FIG. 5 is a flowchart showing a method of adjusting a separation angle of the first polarizing plate shown in FIG. 4.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present.

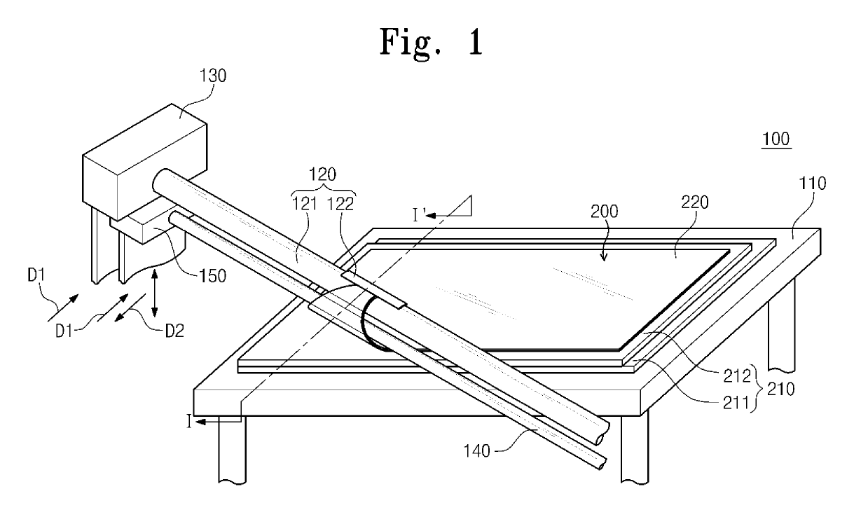

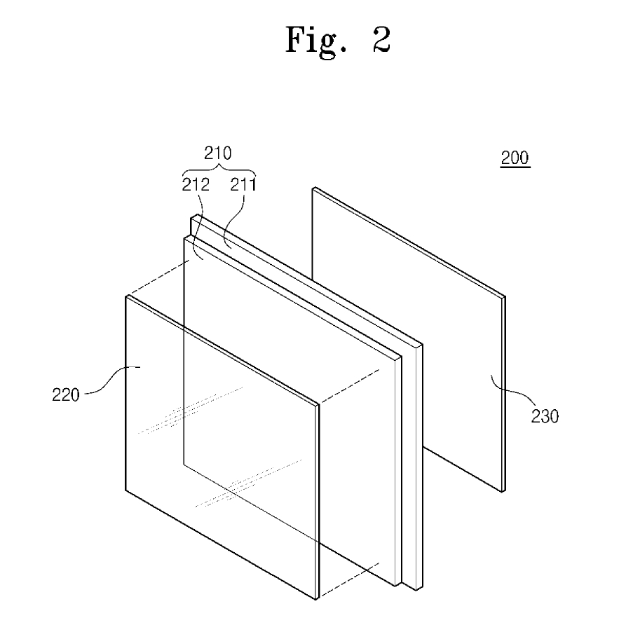

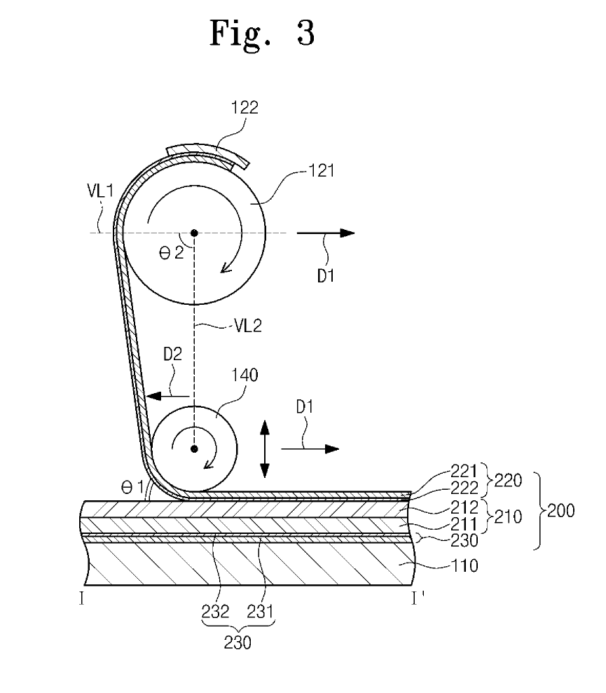

FIG. 1 is a perspective view showing an apparatus for separating a film according to an exemplary embodiment of the present invention, FIG. 2 is an exploded perspective view showing a display panel assembly shown in FIG. 1, and FIG. 3 is a sectional view taken along line I-I′ in FIG. 1.

Referring to FIG. 1, a polarizing plate separator 100 includes a stage 110, a separating roller 120, a first position adjusting unit 130, a guide roller 140, and a second position adjusting unit 150.

A display panel assembly 200 may be disposed on the stage 110. Although not shown in FIG. 1, FIG. 2, and FIG. 3, the stage 110 may be provided with a plurality of holes that are used to fix the display panel assembly 200 thereto using a vacuum.

Here, a configuration of the display panel assembly 200 will be briefly described with reference to FIG. 2. The display panel assembly 200 includes a liquid crystal display panel 210 and first and second polarizing plates 220 and 230 that are attached to upper and lower surfaces of the liquid crystal panel 210, respectively, to polarize light. The liquid crystal display panel 210 includes an array substrate 211, an opposite substrate 212 facing the array substrate 211, and a liquid crystal layer (not shown) interposed between the array substrate 211 and the opposite substrate 212. The first polarizing plate 220 is attached to an upper surface of the opposite substrate 212 to polarize light from the liquid crystal display panel 210. The second polarizing plate 230 is attached to a lower surface of the array substrate 211 to polarize light from a backlight assembly (not shown) provided below the liquid crystal display panel 210.

Referring to FIG. 1, FIG. 2, and FIG. 3, the first and second polarizing plates 220 and 230 include polarizing layers 221 and 231 that polarize light and adhesion layers 222 and 232 formed on surfaces of the polarizing layers 221 and 231, respectively. The first and second polarizing plates 220 and 230 are attached to the liquid crystal display panel 210 by the adhesion layers 222 and 232.

In the present exemplary embodiment, the process of separating the first polarizing plate 220 using the polarizing plate separator is identical to the process of separating the second polarizing plate 230 by using the polarizing plate separator. Accordingly, in the following description, elements of the polarizing plate separator 100 employed to separate the first polarizing plate 220 will be explained as an example.

The separating roller 120 is disposed on the stage 110 to separate the first and second polarizing plates 220 and 230 from the liquid crystal display panel 210. The separating roller 120 includes a roller body 121 and a clip 122 fixing the first polarizing plate 220 to the roller body 121. The roller body 121 may have a cylindrical shape and be provided on the display panel assembly 200 so the roller body 121 can rotate in a clockwise direction while moving in the first direction D1. In the present exemplary embodiment, the roller body 121 rotates in the counterclockwise direction. However, the rotational direction of the roller body 121 may vary depending on the direction in which the roller body 121 moves.

A portion of the first polarizing plate 220 is inserted between the roller body 121 and the clip 122 by means of the clip 122. That is, an edge of the first polarizing plate 220 is inserted between the roller body 121 and the clip 122, and the clip 122 presses the first polarizing plate 220 against the roller body 121. Accordingly, the first polarizing plate 220 is fixed to the roller body 121 while being attached to the liquid crystal display panel 210. Therefore, if the roller body 121 rotates while being moved in the first direction D1, the first polarizing plate 220 gradually separates from the liquid crystal display panel 210 and the separated first polarizing plate 220 is wound around the roller body 121. As an example of the present invention, the roller body 121 may contact the polarizing layer 221 of the first polarizing plate 220 separated from the liquid crystal display panel 210.

One end portion of the roller body 121 is coupled to the first position adjusting unit 130. The first position adjusting unit 130 moves in the first direction D1 and, when viewed in a plan view, adjusts the position of the roller body 121 relative to the first polarizing plate 220. Although only one first position adjusting unit 130 is shown in FIG. 1, a position adjusting unit 130 may be provided at both end portions of the roller body 121.

The guide roller 140 is provided between the separating roller 120 and the first polarizing plate 220. The guide roller 140 has a cylindrical shape, and it may move in the first direction D1 and a second direction D2, which is opposite the first direction D1. The guide roller 140 may also move upward or downward to be positioned adjacent to the first polarizing plate 220.

The guide roller 140 adjusts the separation angle θ₁ between the liquid crystal display panel 210 and the polarizing plate being separated from the liquid crystal display panel 210. That is, the guide roller 140 presses a portion of the first polarizing plate 220, which is separated from the liquid crystal display panel 210 and not wound around the separating roller 120, in the second direction D2. Accordingly, the separation angle θ₁ of the first polarizing plate 220 may be adjusted according to the position and diameter of the guide roller 140. Here, the separation angle θ₁ may vary according to the material and the thickness of the first polarizing plate 220.

In detail, the separation angle θ₁ may be adjusted by a gradient θ₂ of the guide roller 140 relative to the separating roller 120, and the gradient θ₂ of the guide roller 140 depends on the position of the guide roller 140 relative to the separating roller 120. Here, the gradient θ₂ of the guide roller 140 is defined as a gradient of a second virtual line VL2, which connects a central axis of the separating roller 120 and a central axis of the guide roller 140, relative to a first virtual line VL1, which passes through the central axis of the separating roller 120 and parallel to the liquid crystal display panel 210. As an example of the present invention, the gradient θ₂ of the second virtual line VL2 relative to the first virtual line VL1 may be about 45° to about 135°.

The guide roller 140 may be moved upward or downward to be positioned adjacent to the display panel assembly 200, and may be moved in the first and second directions D1 and D2 to adjust the gradient θ₂ of the second virtual line VL2. Therefore, the guide roller 140 may adjust the separation angle θ₁ according to the material and the thickness of the first and second polarizing plates 220 and 230 and may maintain a proper separation angle θ₁ while the first and second polarizing plates 220 and 230 are being separated.

In addition, the guide roller 140 may be moved in the first direction D1 while the first polarizing plate 220 is being separated and may rotate in the same direction as the separating roller 120. Here, the guide roller 140 may be moved at the same speed as the separating roller 120.

As described above, the guide roller 140 may maintain the proper separation angle θ₁ while the first and second polarizing plates 220 and 230 are being separated, thereby preventing the first and second polarizing plates 220 and 230 from being torn in the separation process. In addition, the guide roller 140 may be disposed adjacent to the display panel assembly 200 to prevent the liquid crystal display panel 210 from being lifted up from the stage 110 during the separation process. Accordingly, the polarizing plate separator 100 may improve the rework success rate and use-efficiency of the product.

Meanwhile, one end portion of the guide roller 140 is coupled to the second position adjusting unit 150. The second position adjusting unit 150 may be moved in the first and second directions D1 and D2 and may be moved upward or downward to adjust the position of the guide roller 140. Although only one second position adjusting unit 150 is shown in FIG. 1, a second position adjusting unit 150 may be provided at both end portions of the guide roller 140.

Hereinafter, the separation process of the first polarizing plate 220 will be explained with reference to the drawings.

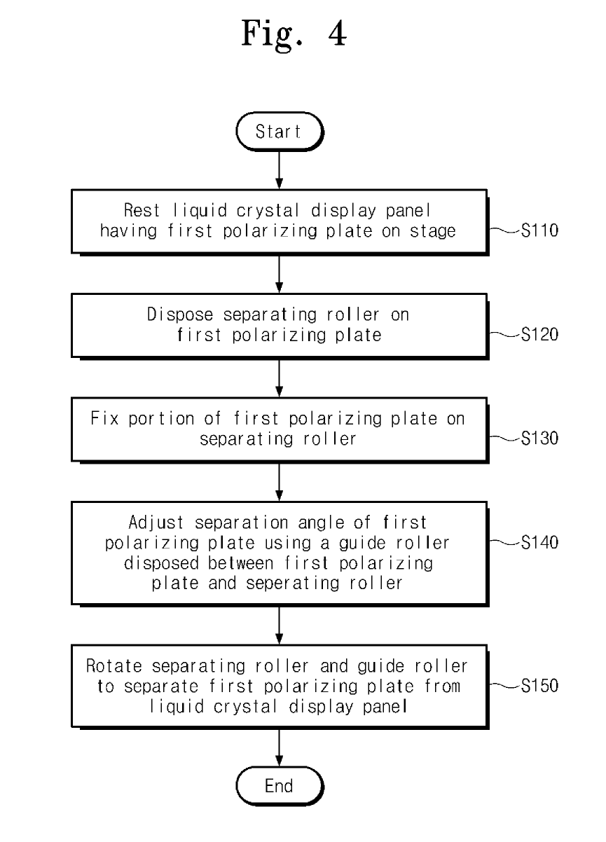

FIG. 4 is a flowchart showing a separation process of a polarizing plate according to an exemplary embodiment of the present invention.

Referring to FIG. 1 and FIG. 4, the liquid crystal display panel 210 having the first polarizing plate 220 on the upper surface thereof is disposed on the upper surface of the stage 110 (S110).

The separating roller 120 is disposed on the first polarizing plate 220 (S120).

The edge of the first polarizing plate 220 is inserted between the clip 122 and the roller body 121 of the separating roller 120, so that the first polarizing plate 220 is fixed to the separating roller 120 (S130).

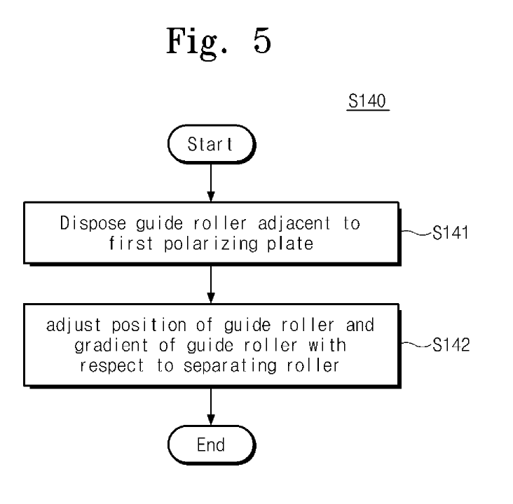

The separation angle θ₁ of the first polarizing plate 220 is adjusted using a guide roller 140 disposed between the first polarizing plate 220 and the separating roller 120 (referring to FIG. 3) (S140). The process of adjusting the separation angle θ₁ of the first polarizing plate 220 will be explained later with reference to FIG. 5.

The separating roller 120 and the guide roller 140 rotate while being moved in the first direction D1, so that the first polarizing plate 220 may be separated from the liquid crystal display panel 210 (S150). That is, if the separating roller 120 rotates while being moved in the first direction D1, the first polarizing plate 220 may be separated from the liquid crystal display panel 210 and wound around the separating roller 120. While the first polarizing plate 220 is being separated, the guide roller 140 presses the portion of the first polarizing plate 220, which is separated from the liquid crystal display panel 210 and not wound around the separating roller 120, in the second direction D2.

FIG. 5 is a flowchart showing a method of adjusting the separation angle of the first polarizing plate shown in FIG. 4.

Referring to FIG. 3 and FIG. 5, the guide roller 140 is provided adjacent to the first polarizing plate 220 (S141).

The guide roller 140 may be moved in the first and second directions D1 and D2 to adjust the gradient θ₂ of the guide roller 140 relative to the separating roller 120 (S142). The separation angle θ₁ of the first polarizing plate 220 is determined according to the gradient θ₂ of the guide roller 140 relative to the separating roller 120 and the diameter of the guide roller 140.

Although the method of separating the first polarizing plate 220 from the liquid crystal display panel 210 has been described, it should be noted that the method of separating the second polarizing plate 230 may be identical to that of the first polarizing plate 220.

According to the present invention, the polarizing plate separator may be provided with the guide roller which adjusts the separation angle of the polarizing plate being separated from the liquid crystal display panel. Therefore, the polarizing plate separator may maintain the proper separation angle while the polarizing plate is being separated, thereby preventing the polarizing plate from being torn in the separation process. In addition, the guide roller may be provided adjacent to the liquid crystal display panel, thereby preventing the liquid crystal display panel from being lifted up from the stage. Accordingly, the polarizing plate separator may improve the rework success rate and use-efficiency of the product.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus for separating a film from a substrate, the apparatus comprising:
a stage on which the substrate may be disposed;
a separating roller that is moveable in a first direction to separate the film from the substrate; and
a guide roller to adjust a separation angle between the film and the substrate.

2. The apparatus of claim 1, wherein the guide roller is adapted to contact a portion of the film that is separated from the substrate and not wound around the separating roller.

3. The apparatus of claim 2, wherein the guide roller is adapted to press the film in a second direction opposite the first direction.

4. The apparatus of claim 1, wherein a gradient of a second virtual line, which connects a central axis of the guide roller to a central axis of the separating roller, relative to a first virtual line, which passes through the central axis of the separating roller and parallel to the substrate, is about 45° to about 135°.

5. The apparatus of claim 4, wherein the guide roller is moveable in the first direction or in a second direction opposite the first direction to adjust the gradient of the second virtual line.

6. The apparatus of claim 1, wherein the separating roller comprises:
a roller body having a cylindrical shape, the roller body being moveable in the first direction; and
a clip coupled with the roller body, the clip to fix the film to the roller body.

7. The apparatus of claim 6, wherein the roller body rotates to wind the film separated from the substrate.

8. The apparatus of claim 7, wherein the guide roller rotates.

9. The apparatus of claim 1, wherein the guide roller is disposed between the stage and the separating roller.

10. A method of separating a film, the method comprising:
disposing a substrate on a stage;
disposing a separating roller on a film of the substrate;
fixing a portion of the film to the separating roller;
adjusting a separation angle between the film and the substrate using a guide roller; and
moving the separating roller in a first direction to separate the film from the substrate.

11. The method of claim 10, wherein adjusting the separation angle comprises;
disposing the guide roller adjacent to the film; and
adjusting the position of the guide roller relative to the separating roller to adjust a gradient of a second virtual line, which connects a central axis of the separating roller to a central axis of the guide roller, relative to a first virtual line, which passes through the central axis of the separating roller and parallel to the substrate.

12. The method of claim 11, wherein the guide roller presses a portion of the film, which is separated from the substrate and not wound around the separating roller, while the film is being separated.

13. The method of claim 12, wherein the guide roller presses the film in a second direction opposite the first direction.

14. The method of claim 11, wherein disposing the guide roller adjacent to the film comprises disposing the guide roller between the substrate and the separating roller.
